(19) United States
(12) Patent Application Publication
(10) Pub. No.: US 2003/0178752 A1
(43) Pub. Date: Sep. 25, 2003

(54) Indium oxide powder, method for preparing the same, and method for manufacturing high-density indium tin oxide target

(76) Inventors: Kyong-Hwa Song, Yongin-City (KR); Sang-Cheol Park, Seoul (KR); Jung-Gyu Nam, Suwon-City (KR)

Correspondence Address: LEE & STERBA, P. C., 1101 Wilson Boulevard, Suite 2000, Arlington, VA, 22209, US

(21) Appl. No.: 10/320,406

(22) Filed: Dec. 17, 2002

(30) Foreign Application Priority Data
Mar. 22, 2002 (KR) 2002-15610

(51) Int. Cl. C04B 35/01

(52) U.S. Cl. 264/681; 423/624

(57) ABSTRACT

In₂O₃ powder, a method for preparing the In₂O₃ powder, and a method for manufacturing an indium tin oxide (ITO) target using the In₂O₃ powder. In the method for preparing the In₂O₃ powder, an alkaline precipitate is added to an indium solution having an indium ion concentration of about 2-5 M at a rate of about 0.5-4 L/min while the pH of the indium solution is adjusted to about 5-9, to form an In(OH)₃ precipitate. Next, the precipitate is precipitated at a temperature of between about 600 to 1,100C. to produce the In₂O₃ powder. The In₂O₃ powder having a surface area of between about 5 to 18 m²/g and an average particle diameter of between about 40 to 160 nm is obtained. The In₂O₃ powder is applicable to form an ITO target for a high-quality, transparent electrode for a display, such as a liquid crystal display, electroluminescent display, or field emission display.

### BACKGROUND OF THE INVENTION

1. Field of the Invention

The present invention relates to indium oxide (In₂O₃) powder, a method for preparing the indium oxide powder, and a method for manufacturing an indium tin oxide (ITO) target. More particularly, the present invention relates to indium oxide powder for a high-density ITO target which is used in vacuum deposition of a high-quality transparent electrode layer of a display such as a liquid crystal display (LC.D), electroluminescent (EL) display, and field emission display (FED), a method for preparing the indium oxide powder, and a method for manufacturing a high-density indium tin oxide target (ITO) using the indium oxide powder.

2. Description of the Related Art

Due to their conductivity and transparency with respect to visible light, ITO films with the composition of In₂O₃ and SnO₂ in a ratio of about 9:1 have been widely used as a transparent electrode film for an LCD, EL, or FED. In general, such an ITO film is coated on an insulating substrate such as a glass substrate by sputtering an ITO target. The ITO target is manufactured by molding ITO powder into a predetermined shape, for example, a rectangular parallelepiped shape, followed by sintering at a high temperature. To form a high-quality ITO film on the substrate by sputtering, the ITO target needs to have a high sintering density. If a low-density ITO target is used to form an ITO film by sputtering, nodules are easily generated on the target surface, thereby lowering the quality and yield of the resulting ITO film.

For this reason, a high-density ITO target is required to form a high-quality, transparent ITO electrode. To form such a high-density ITO target, ITO particles should be of an appropriate primary particle diameter. In general, the ITO particle diameter is inversely proportional to the target's sintering density. Therefore, the particle diameter should be reduced to increase the sintering density of the target. A method that is currently available for forming a high-density target having an approximately theoretical density is to reduce the particle diameter to a nano-scale. To manufacture a high-density target, it is important to adjust the ITO particle diameter to be uniform, as well as to reduce the particle diameter, for the following reasons. If a primary particle diameter of the ITO particles is too small, it is difficult to grind the particles after hydroxide calcination even though the driving force for sintering increases sufficiently for higher sintering density due to an increased specific surface area. It is also difficult to obtain a large molded body due to stress caused from the generation of many fine pores between the particles during target molding. In contrast, if a primary particle diameter of the ITO particles is too large, the fluidity and molding properties of the powder are improved, whereas the driving force for particle sintering is too low, so that pores between the particles become greatly enlarged, thereby increasing the energy requirement for removing the pores. For these reasons, to manufacture a high-density ITO target, the particle diameter should be fine and within a narrow range, and it should be easy to grind secondary particles.

A vapor phase method known for fine powder synthesis has been attracting attention as a method for nano-sized powder synthesis, but is limited to small-scale production of specific powder due to the difficulty of large-scale production. In this method, after powder synthesis, the particle diameter is reduced by grinding. In other words, the particle diameter of secondary particles rather than primary particles, which agglomerate to form the secondary particles, is controlled.

A liquid phase method has been used as a general method of large-scale powder production. Among other liquid phase methods, a precipitation method has been especially widely used to prepare ITO powder by precipitating metallic ions in a solution using a precipitant. In the precipitation method, the powder's characteristics are dependent upon the solution concentration, the reaction pH, the reaction temperature, the type of precipitant, the rate of adding a precipitant, etc.

The inventors of the present invention have discovered that the concentration of the indium solution is an important factor affecting the characteristics of the In₂O₃ powder prepared by precipitation. However, none of the methods of the prior art have limited the concentration of the indium solution for precipitation. As a result, until now, it has been highly difficult to control the surface area and average particle diameter of the In₂O₃ powder even when controlling the pH of the indium solution, the temperature of precipitation reaction, the type of precipitant, the rate of adding the precipitant, etc. Accordingly, until now, it has been difficult to manufacture a high-density ITO target using the In₂O₃ powder prepared by those methods.

### SUMMARY OF THE INVENTION

In order to solve the problems mentioned above, it is a feature of an embodiment of the present invention to provide indium oxide (In₂O₃) powder for a high-density indium tin oxide (ITO) target and a method for preparing the indium oxide powder.

It is a feature of another embodiment of the present invention to provide a method for manufacturing an ITO target having a sintering density of about 7.0-7.15, approximate to a theoretical density level, using the above-prepared In₂O₃ powder.

In one embodiment, there is provided In₂O₃ powder having a surface area of about 5-18 m²/g and an average particle diameter of about 40-160 nm.

In another embodiment, there is provided a method for preparing In₂O₃ powder, including adding an alkaline precipitate to an indium solution having an indium ion concentration of about 2-5 M at a rate of about 0.5-4 L/min while adjusting a pH of the indium solution to about 5-9 to form an In(OH₃) precipitate, and calcining the precipitate at a temperature of between about 600 to 1,100° C. to produce the In₂O₃ powder.

The In₂O₃ powder preparation method may further include dissolving metallic indium of an indium-containing salt in water to form the indium solution, wherein the indium-containing salt includes InCl₃ and In(NO₃)₃.

In the present In₂O₃ powder preparation method, the alkaline precipitant may include NH₄OH, NH₃ gas, NaOH, KOH, NH₄HCO₃, (NH₄)₂CO₃, and a mixture including at least two of the forgoing materials.

The In₂O₃ powder preparation method may further include washing and drying the precipitate before the calcination.

In another embodiment of the present invention, there is provided a method for manufacturing an ITO (indium tin oxide) target, including molding a mixture of about 80-95% by weight In₂O₃ powder having a surface area of about 5-18 m²/g and an average particle diameter of between about 40-160 nm and about 5-20% by weight SnO₂ powder having a surface area of between about 1 to 16 m²/g, and sintering the mixture.

In the ITO target manufacturing method provided by an embodiment of the present invention, the ITO target preferably has a sintering density of between about 7.0 to 7.15 g/cm³, and a sintering temperature of from about 1,200° C. to about 1,600° C.

With the ITO target provided according to an embodiment of the present invention, a high-quality transparent electrode for a display such as a liquid crystal display (LCD), electroluminescent display (EL), or field emission display (FED), may be easily manufactured.

### BRIEF DESCRIPTION OF THE DRAWINGS

The above and other features and advantages of the present invention will become more apparent by describing in detail exemplary embodiments thereof with reference to the attached drawings in which:

FIG. 1 depicts a flowchart for illustrating a method for preparing indium oxide (In₂O₃) powder according to a preferred embodiment of the present invention; and

FIG. 2 depicts a flowchart for illustrating an embodiment of a method for manufacturing an indium tin oxide (ITO) target according to the present invention by mixing SnO₂ powder with the In₂O₃ powder prepared by the method depicted in FIG. 1.

### DETAILED DESCRIPTION OF THE INVENTION

Indium oxide (In₂O₃) powder, a method for preparing the In₂O₃ powder, and a method for manufacturing an indium tin oxide (ITO) target using the In₂O₃ powder according to the present invention will now be described in detail.

The inventors of the present invention have discovered that fine, uniform, highly pure In₂O₃ powder suitable for a high-density ITO target may be prepared by systematically and accurately controlling the concentration of an indium solution as well as the temperature of precipitation reaction, the pH of the indium solution, the calcination temperature of In₂O₃ precipitate.

In preparing fine, uniform, highly pure In₂O₃ powder, the inventors of the present invention have discovered that the concentration of the indium solution is an important factor. According to the mechanism of particle formation by a precipitation method, precipitate nuclei are generated in a reaction solution with the addition of a precipitant. Precipitate nuclei collide and grow into primary particles. These primary particles generate nano-sized powder. In view of the precipitation mechanism, the solution concentration affects the number of precipitate nuclei during the precipitation and the probability of the nuclei colliding, and thus determines the size and shape of the particles. In particular, in a high-concentration reaction solution, precipitate nuclei are more likely to collide so that larger particles than those obtained by using a low-concentration reaction solution may be formed. Due to irregular collisions of particles, particles of a variety of shapes are precipitated. Spherical particles are favorable to increasing the density of a sintered ITO body. In this respect, the concentration of the indium solution is one of the most important factors in preparing In₂O₃ powder. When In₂O₃ powder is formed with the addition of a precipitant to an indium solution, particle shape and size are determined according to the initial concentration of indium. In one embodiment of the present invention, spherical In₂O₃ powder of a particular size and surface area, capable of being sintered into a high-density ITO target, is prepared by adjusting the initial concentration of indium ions in an indium solution.

The present invention also provides a method for manufacturing a high-density ITO target by limiting the average particle diameter of SnO₂ powder to provide a maximum sintering density when mixed with the In₂O₃ powder of a particular size and surface area prepared by the following method according to the present invention.

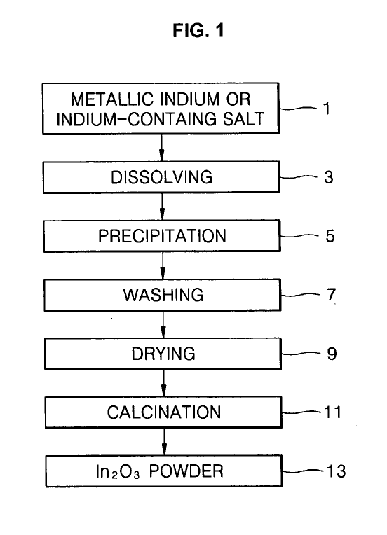

Hereinafter, a method for preparing In₂O₃ powder according to a preferred embodiment of the present invention will be described in detail with reference to FIG. 1.

FIG. 1 depicts a flowchart for illustrating an embodiment of a method for preparing InO₃ powder according to the present invention. Referring to FIG. 1, as a source material for the In₂O₃ powder, metallic indium or any indium-containing salt, such as InCl₃, In(NO₃)₃, etc., may be used (Step 1). When metallic indium is used, an indium solution is obtained by dissolving the metallic indium in an acid such as a nitric acid. When an indium-containing salt is used, an indium solution is prepared by dissolving the indium-containing salt in distilled water (Step 3). The initial concentration of indium ions is controlled to about 2-5 M. If the concentration of indium ions is less than about 2 M, precipitation reaction time is increased, and yield is decreased. If the concentration of indium ions is greater than about 5 M, non-uniform particles are produced because the precipitant is not mixed smoothly due to thickening of the precipitate slurry during precipitation.

Next, an alkaline precipitant is added to the indium solution prepared as described above to obtain In(OH)ₓ precipitate (Step 5). Types of available alkaline precipitants are not limited. For example, NH₄OH, NH₃ gas, NaOH, KOH, NH₄HC.O₃, (NH₄)₂CO₃, and a mixture including at least two of the foregoing materials may be used as the alkaline precipitant. The rate of adding the precipitant is adjusted to about 0.5-4 L/min. If the rate of adding the precipitant is less than about 0.5 L/min, precipitation reaction time is increased. If the rate of adding the precipitant is greater than about 4 L/min, the precipitant is not mixed thoroughly, causing partial precipitation, thereby resulting in non-uniform precipitate particles.

The pH of the indium solution is adjusted to between about 5 to 9. If the pH of the indium solution is less than about 5, the precipitate particles are very small. The pH of the indium solution greater than about 9 may have an adverse effect on the environment due to excess hydroxyl (OH) groups.

Subsequently, the precipitate is aged, separated using a centrifuge, and washed (Step 7). The washed precipitate is dried in an oven (Step 9), ground, and calcined in an electric furnace (Step 11) to obtain In₂O₃ powder. The calcination temperature is adjusted to between about 600 to 1100° C. If the calcination temperature is lower than about 600° C., the average particle diameter of the In₂O₃ powder is too small. If the calcination temperature is higher than about 1100° C., the In₂O₃ powder is sintered.

With the In₂O₃ powder preparation method according to the present invention as described above, In₂O₃ powder having a surface area of about 5-18 m²/g and an average particle diameter of between about 40 to 160 nm when measured by a BET method may be obtained. If a surface area of the In₂O₃ powder measured by the BET method is less than about 5 m²/g (corresponding to an average particle diameter of about 160 nm), the primary average particle diameter is too large to provide enough driving force for a high sintering density. If a surface area of the In₂O₃ powder is larger than about 18 m²/g (corresponding to an average particle diameter of about 50 nm), the primary average particle diameter is too fine to mold the In₂O₃ powder. Accordingly, it is difficult to achieve and obtain both a high molding density and a high sintering density.

Hereinafter, a method for manufacturing a high-density ITO target using the In₂O₃ powder prepared as described above by the method according to the present invention, which has a surface area of about 5-18 m²/g and an average particle diameter of between about 40 to 160 nm when measured by the BET method, will be described.

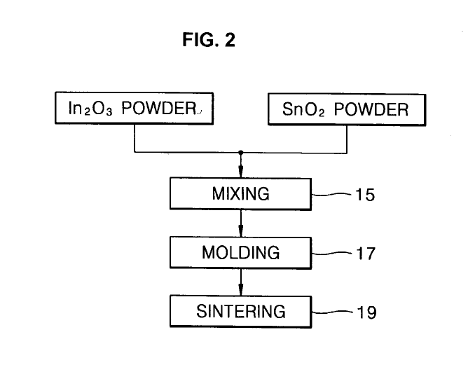

FIG. 2 depicts a flowchart for illustrating a method for preparing a high-density ITO target by mixing SnO₂ powder with the In₂O₃ powder prepared by a method according to the present invention. Referring to FIG. 2, about 80-95% by weight of the In₂O₃ powder prepared according to the present invention and about 5-20% by weight of SnO₂ powder are mixed. The SnO₂ powder has a surface area of between about 1 to 16 m²/g, preferably between about 4 to 15 m²/g, when measured by the BET method. The In₂O₃ and the SnO₂ are mixed by, for example, ball milling (Step 15). The resulting powder mixture is dried and molded into a rectangular parallelepiped target (Step 17). The molded product is thermally treated at between about 1,200 to 1,600° C. in a sintering furnace to obtain an ITO target (Step 19). The characteristics of the final ITO target are evaluated by measuring, for example, the sintering density. If the sintering temperature is lower than about 1,200° C., it is difficult to completely solidify the two oxides during the sintering, and the energy is insufficient for a high sintering density. If the sintering temperature is above about 1,6000° C., which is high enough for phase change and sintering of the oxides, the yield of the ITO target decreases with increasing sintering duration because In₂O₃ and SnO₂ are volatile at high temperatures.

The method for preparing In₂O₃ powder and the method for manufacturing an ITO target according to the present invention will be described in greater detail with reference to the following examples. The following examples are for illustrative purposes and are not intended to limit the scope of the invention.

### Synthesis of SnO₂

A method for synthesizing SnO₂ powder to be mixed with In₂O₃ powder and sintered to form ITO targets in the following examples 1 through 6 and comparative examples 1-7 is described herein. SnC.I₄, was dissolved to obtain a tin ion solution containing tin ions in a concentration of 1.0 M. A precipitant with hydroxyl (−OH) group was added to the solution at a rate of 1 L/min to obtain Sn(OH)x precipitate. The Sn(OH)ₓ precipitate was aged for 20-24 hours, separated using a centrifuge, and washed with distilled water. The washed precipitate was dried at 100° C. in an oven, and the dried powder was ground. The ground powder was calcined in an electric furnace at 700° C. for 2 hours. The resulting SnO₂ powder had a surface area of 10 m²/g when measured by the BET method.

### EXAMPLE 1

A predetermined amount of In(NO₃)₃, equivalent to a final indium ion concentration of 2.5 M, was dissolved in distilled water. A precipitate was obtained by adding 28% NH₄OH as a precipitant to the solution at a rate of 2 L/min. The pH of the solution was adjusted to 8. The resulting precipitate was aged for 18-24 hours, separated using a centrifuge, and washed. The washed precipitate was dried at 100° C. in an oven, and the dried powder was ground by ball milling. The ground powder was calcined in an electric furnace at 700° C. for 2 hours. The resulting In₂O₃ powder had a surface area of 18 m²/g when measured by the BET method.

The In₂O₃ powder prepared as described above and SnO₂ powder having a surface area of 10 m²/g when measured by the BET method were mixed in a weight ratio of 90:10. The powder mixture was molded into a predetermined shape using a mold and sintered. The resulting ITO target of a 20-cm width, 15-cm length, and 1-cm height had a sintering density of 7.13 g/cm³.

### EXAMPLE 2

In EXAMPLE 2, 287.2 g of metallic indium was completely dissolved in 1 L 60%-nitric acid to obtain a 3 M In(NO₃)₃ solution. A precipitate was obtained by adding 28% NH₄OH as a precipitant to the solution at a rate of 2 L/min. The pH of the solution was adjusted to 8. The resulting precipitate was aged for 18-24 hours, separated using a centrifuge, and washed. The washed precipitate was dried at 100° C. in an oven, and the dried powder was ground by ball milling. The ground powder was calcined in an electric furnace at 800° C. for 2 hours. The resulting In₂O₃ powder had a surface area of 17 m²/g when measured by the BET method.

The In₂O₃ powder prepared as described above and SnO₂ powder having a surface area of 10 m²/g when measured by the BET method were mixed in a weight ratio of 90:10. The powder mixture was molded into a predetermined shape and sintered. The resulting ITO target of a 20-cm width, 15-cm length, and 1-cm height had a sintering density of 7.14 g/cm³.

### EXAMPLE 3

A predetermined amount of In(NO₃)₃, equivalent to a final indium ion concentration of 2.5 M, was dissolved in distilled water. A precipitate was obtained by adding 28% NH₄OH as a precipitant to the solution at a rate of 0.5 L/min. The pH of the solution was adjusted to 8. The resulting precipitate was aged for 18-24 hours, separated using a centrifuge, and washed. The washed precipitate was dried at 100° C. in an oven, and the dried powder was ground by ball milling. The ground powder was calcined in an electric furnace at 800° C. for 2 hours. The resulting In₂O₃ powder had a surface area of 16 m²/g when measured by the BET method.

The In₂O₃ powder prepared as described above and SnO₂ powder having a surface area of 10 m²/g when measured by the BET method were mixed in a weight ratio of 90:10. The powder mixture was molded into a predetermined shape using a mold and sintered. The resulting ITO target of a 20-cm width, 15-cm length, and 1-cm height had a sintering density of 7.08 g/cm³.

### EXAMPLE 4

A predetermined amount of In(NO₃)₃ was dissolved in distilled water to obtain an indium solution having an indium ion concentration of 3.0 M. A precipitate was obtained by adding 28% NH₄OH as a precipitant to the solution at a rate of 2 L/min. The pH of the solution was adjusted to 7. The resulting precipitate was stirred, aged for 18-24 hours, separated using a centrifuge, and washed. The washed precipitate was dried at 100° C. in an oven, and the dried powder was ground by ball milling. The ground powder was calcined in an electric furnace at 800° C. for 2 hours. The resulting In₂O₃ powder had a surface area of 14 m²/g when measured by the BET method.

The In₂O₃ powder prepared as described above and SnO₂ powder having a surface area of 10 m²/g when measured by the BET method were mixed in a weight ratio of 90:10. The powder mixture was molded into a predetermined shape using a mold and sintered. The resulting ITO target of a 20-cm width, 15-cm length, and 1-cm height had a sintering density of 7.10 g/cm³.

### EXAMPLE 5

A predetermined amount of In(NO₃)₃ was dissolved in distilled water to obtain an indium solution having an indium ion concentration of 2.5 M was dissolved in distilled water. A precipitate was obtained by adding 28% NH₄OH as a precipitant to the solution at a rate of 2 L/min. The pH of the solution was adjusted to 7. The resulting precipitate was stirred, aged for 18-24 hours, separated using a centrifuge, and washed. The washed precipitate was dried at 100° C. in an oven, and the dried powder was ground by ball milling. The ground powder was calcined in an electric furnace at 850° C. for 2 hours. The resulting In₂O₃ powder had a surface area of 11 m²/g when measured by the BET method.

The In₂O₃ powder prepared as described above and SnO₂ powder having a surface area of 10 m²/g when measured by the BET method were mixed in a weight ratio of 90:10. The powder mixture was molded into a predetermined shape using a mold and sintered. The resulting ITO target of a 20-cm width, 15-cm length, and 1-cm height had a sintering density of 7.13 g/cm³.

### EXAMPLE 6

A predetermined amount of In(NO₃)₃ was dissolved in distilled water to obtain an indium solution having an indium ion concentration of 2.5 M. A precipitate was obtained by adding 28% NH₄OH as a precipitant to the solution at a rate of 1 L/min. The pH of the solution was adjusted to 7 .

The resulting precipitate was stirred, aged for 18-24 hours, separated using a centrifuge, and washed. The washed precipitate was dried at 100° C. in an oven, and the dried powder was ground by ball milling. The ground powder was calcined in an electric furnace at 850° C. for 2 hours. The resulting In₂O₃ powder had a surface area of 12 m²/g when measured by the BET method.

The In₂O₃ powder prepared as described above and SnO₂ powder having a surface area of 10 m²/g when measured by the BET method were mixed in a weight ratio of 90:10. The powder mixture was molded into a predetermined shape using a mold and sintered. The resulting ITO target of a 20-cm width, 15-cm length, and 1-cm height had a sintering density of 7.12 g/cm³.

### COMPARATIVE EXAMPLE 1

A predetermined amount of In(NO₃)₃ was dissolved in distilled water to obtain an indium solution having an indium ion concentration of 1 M. A precipitate was obtained by adding 28% NH₄OH as a precipitant to the solution at a rate of 2 L/min. The pH of the solution was adjusted to 8. The resulting precipitate was stirred, aged for 18-24 hours, separated using a centrifuge, and washed. The washed precipitate was dried at 100° C. in an oven, and the dried powder was ground by ball milling. The ground powder was calcined in an electric furnace at 700° C. for 2 hours. The resulting In₂O₃ powder had a surface area of 25 m²/g when measured by the BET method.

The In₂O₃ powder prepared as described above and SnO₂ powder having a surface area of 10 m²/g when measured by the BET method were mixed in a weight ratio of 90:10. The powder mixture was molded into a predetermined shape using a mold and sintered. The resulting ITO target had a sintering density of 6.91 g/cm³.

### COMPARATIVE EXAMPLE 2

A predetermined amount of In(NO₃)₃ was dissolved in distilled water to obtain an indium solution having an indium ion concentration of 2.5 M. A precipitate was obtained by adding 28% NH₄OH as a precipitant to the solution at a rate of 0.05 L/min to obtain a precipitate. The pH of the solution was adjusted to 8. The resulting precipitate was stirred, aged for 18-24 hours, separated using a centrifuge, and washed. The washed precipitate was dried at 100° C. in an oven, and the dried powder was ground by ball milling. The ground powder was calcined in an electric furnace at 700° C. for 2 hours. The resulting In₂O₃ powder had a surface area of 30 m²/g when measured by the BET method.

The In₂O₃ powder prepared as described above and SnO₂ powder having a surface area of 10 m²/g when measured by the BET method were mixed in a weight ratio of 90:10. The powder mixture was molded into a predetermined shape using a mold and sintered. The resulting ITO target had a sintering density of 6.30 g/cm³.

### COMPARATIVE EXAMPLE 3

A predetermined amount of In(NO₃)₃ was dissolved in distilled water to obtain an indium solution having an indium ion concentration of 2.5 M. A precipitate was obtained by adding 28% NH₄OH as a precipitant to the solution at a rate of 2 L/min. The pH of the solution was adjusted to 4. The resulting precipitate was stirred, aged for 18-24 hours, separated using a centrifuge, and washed. The washed precipitate was dried at 100° C. in an oven, and the dried powder was ground by ball milling. The ground powder was calcined in an electric furnace at 700° C. for 2 hours. The resulting In₂O₃ powder had a surface area of 23 m²/g when measured by the BET method.

The In₂O₃ powder prepared as described above and SnO₂ powder having a surface area of 10 m²/g when measured by the BET method were mixed in a weight ratio of 90:10. The powder mixture was molded into a predetermined shape using a mold and sintered. The resulting ITO target had a sintering density of 6.60 g/cm³.

### COMPARATIVE EXAMPLE 4

predetermined amount of In(NO₃)₃ was dissolved in distilled water to obtain an indium solution having an indium ion concentration of 2.5 M. A precipitate was obtained by adding 28% NH₄OH as a precipitant to the solution at a rate of 2 L/min to obtain a precipitate. The pH of the solution was adjusted to 8. The resulting precipitate was stirred, aged for 18-24 hours, separated using a centrifuge, and washed. The washed precipitate was dried at 100° C. in an oven, and the dried powder was ground by ball milling. The ground powder was calcined in an electric furnace at 500° C. for 2 hours. The resulting In₂O₃ powder had a surface area of 32 m²/g when measured by the BET method.

The In₂O₃ powder prepared as described above and SnO₂ powder having a surface area of 10 m²/g when measured by the BET method were mixed in a weight ratio of 90:10. The powder mixture was molded into a predetermined shape using a mold and sintered. The resulting ITO target had a sintering density of 6.48 g/cm³.

### COMPARATIVE EXAMPLE 5

A predetermined amount of In(NO₃)₃ was dissolved in distilled water to obtain an indium solution having an indium ion concentration of 5.5 M. A precipitate was obtained by adding 28% NH₄OH as a precipitant to the solution at a rate of 2 L/min to obtain a precipitate. The pH of the solution was adjusted to 8. The viscosity of the slurry was high due to the high-concentration reaction solution. The resulting precipitate was stirred, aged for 18-24 hours, separated using a centrifuge, and washed. The washed precipitate was dried at 100° C. in an oven, and the dried powder was ground by ball milling. The ground powder was calcined in an electric furnace at 800° C. for 2 hours. The resulting In₂O₃ powder had a surface area of 4.5 m²/g when measured by the BET method.

The In₂O₃ powder prepared as described above and SnO₂ powder having a surface area of 10 m²/g when measured by the BET method were mixed in a weight ratio of 90:10. The powder mixture was molded into a predetermined shape using a mold and sintered. The resulting ITO target had a sintering density of 6.18 g/cm³.

### COMPARATIVE EXAMPLE 6

A predetermined amount of In(NO₃)₃ was dissolved in distilled water to obtain an indium solution having an indium ion concentration of 2.5 M. A precipitate was obtained by adding 28% NH₄OH as a precipitant to the solution at a rate of 2 L/min to obtain a precipitate. The pH of the solution was adjusted to 8. The resulting precipitate was stirred, aged for 18-24 hours, separated using a centrifuge, and washed. The washed precipitate was dried at 100° C. in an oven, and the dried powder was ground by ball milling. The ground powder was calcined in an electric furnace at 1200° C. for 2 hours. Observation using a scanning electron microscope (SEM), after the calcination, indicated that the particles had grown significantly. The resulting In₂O₃ powder had a surface area of 4.3 m²/g when measured by the BET method.

The In₂O₃ powder prepared as described above and SnO₂ powder having a surface area of 10 m²/g when measured by the BET method were mixed in a weight ratio of 90:10. The powder mixture was molded into a predetermined shape using a mold and sintered. The resulting ITO target had a sintering density of 6.51 g/cm³.

### COMPARATIVE EXAMPLE 7

A predetermined amount of In(NO₃)₃ was dissolved in distilled water to obtain an indium solution having an indium ion concentration of 3.0 M. A precipitate was obtained by adding 28% NH₄OH as a precipitant to the solution at a rate of 2 L/min to obtain a precipitate. The pH of the solution was adjusted to 10. The resulting precipitate was stirred, aged for 18-24 hours, separated using a centrifuge, and washed. There was a strong ammonia smell during the wash. The washed precipitate was dried at 100° C. in an oven, and the dried powder was ground by ball milling. The ground powder was calcined in an electric furnace at 800° C. for 2 hours. Observation using a scanning electron microscope (SEM), after the calcination, indicated that the particles had grown significantly. The resulting In₂O₃ powder had a surface area of 31 m²/g when measured by the BET method.

The In₂O₃ powder prepared as described above and SnO₂ powder having a surface area of 10 m²/g when measured by the BET method were mixed in a weight ratio of 90:10. The powder mixture was molded into a predetermined shape using a mold and sintered. The resulting ITO target had a sintering density of 6.67 g/cm³.

The main In₂O₃ powder preparation conditions and the sintering density of each of the ITO targets in examples 1 through 6 and comparative examples 1 through 7 are shown in Table 1.

TABLE 1

| | | | | | | | | | Sintering |
|---|---|---|---|---|---|---|---|---|---|
| | Indium | Rate of | | | Surface | Particle | Surface | Particle | Density |
| | Concen- | Precipitant | | Calcination | Area of | Diameter | Area of | Diameter | of ITO |
| | tration | Addition | Reaction | Temperature | In₂O₃ | of In₂O₃ | SnO₂ | of SnO₂ | target |
| Example | (M) | (L/min) | pH | (° C.) | (m²/g) | (nm) | (m²/g) | (nm) | (g/cm³) |
| Example 1 | 2.5 | 2 | 8 | 700 | 18 | 46 | 10 | 86 | 7.13 |
| Example 2 | 3.0 | 2 | 8 | 800 | 17 | 49 | 10 | 86 | 7.14 |
| Example 3 | 2.5 | 0.5 | 8 | 800 | 16 | 52 | 10 | 86 | 7.08 |
| Example 4 | 3.0 | 2 | 7 | 800 | 14 | 60 | 10 | 86 | 7.10 |
| Example 5 | 2.5 | 2 | 7 | 850 | 11 | 76 | 10 | 86 | 7.13 |
| Example 6 | 2.5 | 1 | 7 | 850 | 12 | 70 | 10 | 86 | 7.12 |
| Comparative | 1.0 | 2 | 8 | 700 | 25 | 34 | 10 | 86 | 6.91 |
| Example 1 | | | | | | | | | |
| Comparative | 2.5 | 0.05 | 8 | 700 | 30 | 28 | 10 | 86 | 6.30 |
| Example 2 | | | | | | | | | |
| Comparative | 2.5 | 2 | 4 | 700 | 23 | 36 | 10 | 86 | 6.60 |
| Example 3 | | | | | | | | | |
| Comparative | 2.5 | 2 | 8 | 500 | 32 | 26 | 10 | 86 | 6.48 |
| Example 4 | | | | | | | | | |
| Comparative | 5.5 | 2 | 8 | 800 | 4.5 | 187 | 10 | 86 | 6.18 |
| Example 5 | | | | | | | | | |
| Comparative | 2.5 | 2 | 8 | 1,200 | 4.3 | 195 | 10 | 86 | 6.51 |
| Example 6 | | | | | | | | | |
| Comparative | 3.0 | 2 | 10 | 800 | 31 | 27 | 10 | 86 | 6.67 |
| Example 7 | | | | | | | | | |

According to the present invention, In₂O₃ powder may be prepared as in examples 1 through 6 by adjusting the concentration of the indium solution as well as the rate of adding the precipitant, the pH of the indium solution, and the calcination temperature and sintering the mixture. As is apparent from Table 1, by mixing SnO₂ powder with the In₂O₃ powder prepared according to the present invention, a high-density ITO target of about above 7.0 g/cm³ may be manufactured. Especially, in the case of examples 1, 2, 5, and 6, a very high sintering density, approximate to a theoretical density of 7.15 g/cm³, may be obtained for the ITO targets.

According to a preparation method of the present invention, it is possible to conveniently manufacture In₂O₃ powder having a uniform primary average particle diameter of 40-160 nm, which may be further ground into secondary particles of a size (D50 or D90) less than 1 pm. Through sintering after mixing SnO₂ powder of a uniform average particle diameter with the In₂O₃ powder prepared by the method according to the present invention, a high-density ITO target may be manufactured. The high-density ITO target according to the present invention is applicable for a high-quality, transparent electrode film for an LCD, EL, FED, etc. by sputtering in a vacuum.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. In₂O₃ powder having a surface area of about 5-18 m²/g and an average particle diameter of about 40-160 nm.

2. A method for preparing In₂O₃ powder, comprising:
adding an alkaline precipitate to an indium solution having an indium ion concentration of about 2-5 M at a rate of about 0.5-4 L/min while adjusting a pH of the indium solution to about 5-9 to form a In(OH₃) precipitate; and
calcining the precipitate at a temperature of between about 600 to 1,100° C. to produce the In₂O₃ powder.

3. The method as claimed in claim 2, further comprising dissolving metallic indium in water to form the indium solution.

4. The method as claimed in claim 2, further comprising dissolving an indium-containing salt in water to form the indium solution.

5. The method as claimed in claim 4, wherein the indium-containing salt includes InCl₃ and In(NO₃)₃.

6. The method as claimed in claim 2, wherein the alkaline precipitant includes NH₄OH, NH₃ gas, NaOH, KOH, NH₄HCO₃, (NH₄)₂CO₃, and a mixture including at least two of the forgoing materials.

7. The method as claimed in claim 2, further comprising washing and drying the precipitate before the calcinations.

8. A method for manufacturing an ITO (indium tin oxide) target, comprising:
molding a mixture of about 80-95% by weight In₂O₃ powder having a surface area of about 5-18 m²/g and an average particle diameter of between about 40 to 160 nm and about 5-20% by weight SnO₂ powder having a surface area of between about 1 to 16 m²/g; and
sintering the mixture.

9. The method as claimed in claim 8, wherein the ITO target has a sintering density of between about 7.0 to 7.15 g/cm³.

10. The method as claimed in claim 8, wherein a sintering temperature for the ITO target is from about 1,200° C. to about 1,600° C.
